(19) United States
(12) Patent Application Publication
(10) Pub. No.: US 2009/0076743 A1
(43) Pub. Date: Mar. 19, 2009

(54) NOVEL METHOD FOR ZERO POINT DETECTION

(75) Inventors: ALEXANDER J. MOSESON, HAVERTOWN, PA (US); SANDIP BASU, SECANE, PA (US); MICHEL W. BARSOUM, MOORESTOWN, NJ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: DREXEL UNIVERSITY, PHILADELPHIA, PA (US)

(21) Appl. No.: 12/184,711

(22) Filed: Aug. 1, 2008

Related U.S. Application Data
(60) Provisional application No. 60/953,361, filed on Aug. 1, 2007.

(51) Int. Cl. G01L 1/00

(52) U.S. Cl. 702/42

(57) ABSTRACT

The present invention relates to a method for the simple, objective and accurate determination the zero point or effective zero point of a material, the point of first contact between an indenter tip and the surface of a material. The zero point is determined by using a sensor having a tip and capable of continuous stiffness measurement. By applying a data shift, which insures that the stiffness versus contact parameter curve is linear and goes through the origin of the graph, it is possible to determine the zero point based on combined data from indentation and from superimposed continuous stiffness measurement oscillations.

### STATEMENT OF GOVERNMENT INTEREST

This invention was reduced to practice with Government support under Grant No. DAAD19-03-1-0213 awarded by Army Research Office; the Government is therefore entitled to certain rights to this invention.

### BACKGROUND OF THE INVENTION

1. Field of the Invention

The present invention relates to a method for objectively and accurately determining the zero point or effective zero point of a nano-indented material. The novel method of the present application may be particularly useful in enhancing the accuracy of nano-indentation analysis, providing a better understanding of contact mechanics, and positioning a nanoindenter relative to a surface of an object. Additionally, the method may be used to analyze the surface topography and mechanical characteristics of a material.

2. Description of the Related Technology

Instrumented indentation is a valuable and effective method for characterizing the mechanical behavior of materials, especially that of single crystals and thin films. Scientists, such as Hertz, Oliver, Pharr, Field and Swain, have developed a variety of techniques for instrumented indentation but recognize that there are significant hurdles that have yet to be overcome (J. S. Field and M. V. Swain: Determining The Mechanical-Properties Of Small Volumes Of Material From Submicrometer Spherical Indentations. Journal Of Materials Research 10, 101-112 (1995); J. S. Field and M. V. Swain: The Indentation Characterisation Of The Mechanical Properties Of Various Carbon Materials: Glassy Carbon, Coke And Pyrolytic Graphite. Carbon 34, 1357 (1996); W. C. Oliver and G. M. Pharr: Measurement of hardness and elastic modulus by instrumented indentation: Advances in understanding and refinements to methodology. Journal of Materials Research 19, 3-20 (2004)). One such obstacle is the accurate and reliable determination of the zero point, the location where the indenter tip makes first contact with the surface of a solid (W. C. Oliver and G. M. Pharr: Measurement of hardness and elastic modulus by instrumented indentation: Advances in understanding and refinements to methodology. Journal of Materials Research 19, 3-20 (2004); J. L. Bucaille, E. Felder, and G. Hochstetter: Identification of the viscoplastic behavior of a polycarbonate based on experiments and numerical modeling of the nano-indentation test. Journal of Materials Science 37 (2002); P. Grau, G. Berg, W. Fraenzel, and H. Meinhard: Recording hardness testing problems of measurement at small indentation depths Phys. Status Solidi. A 146, 537-548 (1994); N. Huber and E. Tyulyukovskiy: A new loading history for identification of viscoplastic properties by spherical indentation. Journal of Materials Research 19, 101-113 (2004); Z. Li, K. Herrmann, and F. Pohlenz: A comparative approach for calibration of the depth measuring system in a nanoindentation instrument. Measurement 39, 547-552 (2006); B. Rother, A. Steiner, D. A. Dietrich, H. A. Jehn, J. Haupt, and W. Gissler: Depth-sensing indentation measurements with Vickers and Berkovich indenters. Journal of Materials Research 13 (1998); E. Tyulyukovskiy and N. Huber: Neural networks for tip correction of spherical indentation curves from bulk metals and thin metal films. Journal of the Mechanics and Physics of Solids 55, 391-418 (2007)). At this point, although the sample stiffness may appear positive, both the applied indentation load, P, and the total displacement or indentation depth, hₜ, are zero.

To date, methods of various levels of sophistication have been proposed to qualitatively or quantitatively determine the location of the zero point (T. Chudoba, M. Griepentrog, A. Dück, D. Schneider, and F. Richter: Young's modulus measurements on ultra-thin coatings. Journal of Materials Research 19, 301-314 (2004); T. Chudoba, N. Schwarzer, and F. Richter: Determination of elastic properties of thin films by indentation measurements with a spherical indenter. Surface and Coatings Technology 127, 9-17 (2000); A. C. Fischer-Cripps: Critical review of analysis and interpretation of nanoindentation test data. Surface and Coatings Technology 200, 4153-4165 (2006); Y.-H. Liang, Y. Arai, K. Ozasa, M. Ohashi, and E. Tsuchida: Simultaneous measurement of nanoprobe indentation force and photoluminescence of InGaAs/GaAs quantum dots and its simulation. Physica E: Low-dimensional Systems and Nanostructures 36, 1-11 (2007); Y. Y. Lim and M. Munawar Chaudhri: Indentation of elastic solids with a rigid Vickers pyramidal indenter. Mechanics of Materials 38, 1213-1228 (2006); V. Linss, N. Schwarzer, T. Chudoba, M. Karniychuk, and F. Richter: Mechanical properties of a graded B—C—N sputtered coating with varying Young's modulus: deposition, theoretical modelling and nanoindentation. Surface and Coatings Technology 195, 287-297 (2005); F. Richter, M. Herrmann, F. Molnar, T. Chudoba, N. Schwarzer, M. Keunecke, K. Bewilogua, X. W. Zhang, H. G. Boyen, and P. Ziemann: Substrate influence in Young's modulus determination of thin films by indentation methods: Cubic boron nitride as an example. Surface and Coatings Technology 201, 3577-3587 (2006); C. Ullner: Requirement of a robust method for the precise determination of the contact point in the depth sensing hardness test. Measurement 27, 43-51 (2000)). One conventional method involves plotting the applied indentation load P versus the indentation depth hₜ; the zero point is identified as the point where P first exceeds a selected threshold value. Another known method uses a video camera positioned perpendicular to the indentation axis to visually determine when the tip of a sensor has contacted the surface of a material, by analyzing the absence of light passing through a non-existent gap between the tip and surface. This method, however, has limited accuracy of approximately 5 μm (microns) (Y. Y. Lim and M. Munawar Chaudhri: Indentation of elastic solids with a rigid Vickers pyramidal indenter. Mechanics of Materials 38, 1213-1228 (2006); F. Richter, M. Herrmann, F. Molnar, T. Chudoba, N. Schwarzer, M. Keunecke, K. Bewilogua, X. W. Zhang, H. G. Boyen, and P. Ziemann: Substrate influence in Young's modulus determination of thin films by indentation methods: Cubic boron nitride as an example. Surface and Coatings Technology 201, 3577-3587 (2006)). According to Oliver and Pharr (W. C. Oliver and G. M. Pharr: Measurement of hardness and elastic modulus by instrumented indentation: Advances in understanding and refinements to methodology. Journal of Materials Research 19, 3-20 (2004)), it is also possible to determine the location of the zero point using an instrument capable of continuous stiffness measurement; the zero point is the point at which the stiffness, S, first exceeds 200 N/m. This method operates on the assumption that while the tip is hanging free, other factors such as vibration produce stiffness values below 200 N/m and that the small value of 200 N/m first appears when the tip makes contact with the surface. Although the method of Oliver and Pharr can be used to determine the zero point in certain instances, for various reasons it is prone to erroneous identification of the location of interest up to about 450 nm away from the actual zero point. In yet another method, Chudoba, Ullner and their colleagues suggest using regression analysis on a graph of P versus hₜ (T. Chudoba, M. Griepentrog, A. Dück, D. Schneider, and F. Richter: Young's modulus measurements on ultra-thin coatings. Journal of Materials Research 19, 301-314 (2004); T. Chudoba, N. Schwarzer, and F. Richter: Determination of elastic properties of thin films by indentation measurements with a spherical indenter. Surface and Coatings Technology 127, 9-17 (2000); C. Ullner: Requirement of a robust method for the precise determination of the contact point in the depth sensing hardness test. Measurement 27, 43-51 (2000)). The method of Chudoba involves using an iterative numerical function to fit the data of P versus hₜ to a variation of the Hertzian model, replacing the conventional parameters of tip geometry, in the case of a spherical shaped tip, the radius, and effective modulus with an optimized proportionality constant, forcing the data to go through an origin of the graph (T. Chudoba, N. Schwarzer, and F. Richter: Determination of elastic properties of thin films by indentation measurements with a spherical indenter. Surface and Coatings Technology 127, 9-17 (2000)). Ullner's method uses a similar technique for analyzing the data of P versus hₜ, but further suggests optimizing to a second order polynomial (C. Ullner: Requirement of a robust method for the precise determination of the contact point in the depth sensing hardness test. Measurement 27, 43-51 (2000)). These methods are limited in that both load and displacement values are greatly impacted by the zero point, especially at very shallow depths. Although these methods may produce some successful results, because both P and hₜ, are significantly affected by the zero point, they do not provide an objective determination of the zero point. Furthermore, especially at very shallow depths, other factors such as vibration and thermal drift can impact the determination of the zero point, and, in many cases, separating these factors using these conventional methods may not be possible.

Current methods for identifying the zero point of a nano-indented material are typically subjective, inaccurate and/or susceptible to factors that impact and interfere with the accuracy of the determination of the zero point. A method capable of objectively, robustly and accurately determining the location of the zero point has, to date, remained elusive. Therefore, there exists a need to develop a method that would enable an accurate and objective means for reliably and reproducibly determining from an existing data set the zero point for a material.

### SUMMARY OF THE INVENTION

The present invention is directed to a method for objectively and accurately determining the zero point or effective zero point of a nano-indented material.

The method comprises the steps of: obtaining continuous stiffness measurement oscillation data for a nano-indented material; plotting a stiffness of the material as a function of a contact parameter of the material for at least one identified data point; and applying a linear regression analysis to determine the degree to which the data point approximates a line that passes through the origin.

### BRIEF DESCRIPTION OF THE DRAWINGS

FIG. 1(a) is a graph of stiffness S versus contact parameter a for various δ values for a fused silica sample. Inset 1 is a graph of applied load P versus indentation depth hₜ at a region near the point where S=200 N/m. Inset 2 is a graph of S versus a for the full data set.

FIG. 1(b) is a graph of indentation stress versus indentation strain for various δ values for the fused silica sample. The solid line is linear regression for a first loading region of the center curve; the dashed line is the expected slope as calculated from 4E_{eff}/3π. The inset is a graph of the linear regression R-values and the standard error of the S versus a lines of FIG. 1(a) forced through the origin of the graph, at various δ.

FIG. 2(a) is a graph of indentation stress versus indentation strain for various δ values for an annealed iron sample. The inset is a graph of applied load P versus indentation depth hₜ at a region near the point where S=200 N/m.

FIG. 2(b) is a graph of indentation stress versus indentation strain for various δ values for the annealed iron sample. The solid line is linear regression for first loading region of the center curve, the dashed line is the expected slope as calculated from 4E_{eff}/3π. The inset is a graph of the linear regression R-values and the standard error of the S versus a lines of FIG. 2(a) forced through the origin of the graph, at various δ.

FIG. 3(a) is a graph of indentation stress versus indentation strain for various δ values for a sapphire sample. The inset is a graph of applied load P versus indentation depth hₜ at a region near the point where S=200 N/m.

FIG. 3(b) is a graph of indentation stress versus indentation strain for various δ values for the sapphire sample. The solid line is linear regression for first loading region of the center curve, the dashed line is the expected slope as calculated from 4E_{eff}/3π. The inset is a graph of the linear regression R-values and the standard error of the S versus a lines of FIG. 3(a) forced through the origin of the graph, at various δ.

FIG. 4 is a graph of the slope of S versus a, such as those curves shown in FIGS. 1(a), 2(a), and 3(b), versus δ for samples of fused silica, iron and sapphire. The arrows indicate the proper corresponding y-axis for each data set.

### DETAILED DESCRIPTION OF THE PREFERRED EMBODIMENTS

The present invention is directed to a novel method for determining the zero point or effective zero point of a nano-indented material, i.e. the point of first contact between an indenter tip and the surface of a material. According to the present invention, it is possible to determine the location of the zero point or effective zero point of any material, including solid materials such as metals or ceramics and semi-solid materials, using a simple and objective procedure that produces accurate results, which can be reproduced using a sensor capable of continuous stiffness measurement (CSM).

The method of the present invention utilizes a sensor that is equipped with a means for continuous stiffness measurement. Preferably, the sensor is a nanoindenter or an instrumented indenter with a CSM option, attachment or capability. The sensor comprises a tip, which can have any geometrical shape, a means for controlling and/or determining the displacement of the tip relative to any chosen datum and a means for controlling and/or measuring the force applied by the tip onto a solid or semi-solid material.

The sensor may be used for a variety of applications, including but not limited to producing load-displacement curves, marking samples for further inspection, calculating values from the data obtained and mapping data to indentation stress-strain curves. Examples of these applications are shown in S. Basu, A. Moseson, and M. W. Barsoum On the determination of spherical nanoindentation stress-strain curves. Journal of Materials Research 21, 2628-2637 (2006); S. Basu and M. W. Barsoum: On the Use of Spherical Nanoindentations to Determine the Deformation Micromechanisms of ZnO Single Crystals. J. Mater. Res., 22, 2470-2477 (2007); and S. Basu, M. W. Barsoum, A. D. Williams, and T. D. Moustakas: Spherical Nano-indentation and Deformation Mechanisms in Free-standing GaN Films. J. App. Phys. 100, 083522 (2007), the disclosures of which are hereby incorporated by reference herein. In the present invention, the sensor may be used to produce indentation stress-strain curves from load displacement curves by detecting CSM oscillations. CSM is a technique which applies an oscillating force superimposed on the indenting motion of a sensor tip, with both load and displacement on scales considerably smaller than the primary indentation. Resolution of the sensor and the sensitivity of the method of the present invention which uses said sensor, are dependant upon many instrument factors including but not limited to vibration, thermal drift, testing factors such as loading rate and characteristics of the material being tested such as surface roughness. In a preferred embodiment, the sensor has a displacement resolution of about 1 nm or less and a force resolution of about 0.5 millinewtons (mN).

The method of the present invention generally comprises the steps of using a sensor to detect a load and displacement for the primary indentation and for oscillations from continuous stiffness measurements which are superimposed on the primary indentation; systematically shifting the data, creating a data set for each shift; plotting a graph of a stiffness of said material versus a contact parameter of the material for each data point in the data sets; using at least one linear regression means to determine the degree to which each data set approximates a straight lines that passes through the origin of the graph; and selecting a zero point or effective zero point from said data sets. Optionally, the last step may be carried out based on a data shift for which the linear regression most closely approximates a line that passes through the origin of said graph.

Using the data collected by the sensor, the method of the present invention involves generating a graph of material stiffness S as a function of a contact parameter a to determine the zero point or effective zero point of a nanoindented material. The graph of S as a function of a should produce a line that passes through the origin of the graph with a slope of twice the effective modulus for a properly zeroed sample. The graph of S versus a will be linear and pass through the origin of the graph, if and only if, the correct zero point or effective zero point is chosen. Even small errors regarding the location of the zero point or effective zero point will yield significant S versus a errors for small displacements.

The method of the present invention determines the location of the datum point at which first contact is made, δ, which is the difference in hₜ, between the true zero point X_{z} and the first point Xₒ. To find δ, points Xⱼ are chosen near the measured zero point, where the load becomes positive. Preferably, points Xⱼ are within about ±100 nm of the zero point, more preferably within about ±50 nm of the zero point, and most preferably within about ±10 nm of the zero point in order to reduce the number of calculations necessary to determine the true zero point. Each of these points are treated as if they were X_{z}. At X_{z}, both P and hₜ should be zero; to fulfill this requirement, δⱼ must be defined by the value of h_{t,j} and Pⱼ and h_{t,j} must be subtracted from all data points. Since S is actually measured from the CSM oscillations, and thus not affected by the zero point, its value remains unchanged for each point. Points with negative hₜ are then discarded. The result is several data sets, each assuming that Xⱼ, with its corresponding δⱼ, is X_{z} the zero point. A graph of S as a function of a is then plotted for these data sets, and linear regression is used to quantitatively determine the degree to which each set approximates a straight line forced through the origin, which is the ideal form. The slope of these lines is not forced, nor do any of the data sets interact. At least one measure may be used to analyze and quantify the curve fit. In a preferred embodiment, the fit of the curve is analyzed by determining the standard error, which is defined as the average vertical difference between each data point and the line of best fit, which for the purpose of determining the zero point is the line which passes through the origin of the graph of S versus a, and by determining correlation coefficient, R. The value of δⱼ that minimizes the error or maximizes R is assumed to be δ.

According to this method, the zero point may be determined within a resolution of about 2 nm or less and more preferably within a resolution of about 1 nm or less. This is however, dependant upon the resolution of the instrument, as previously indicated. There is no theoretical limit to the resolution of this invention. Errors in determining the zero point of even a few nm can drastically alter further calculations and other uses of the data, such as producing stress-strain curves and S vs. a curves.

Using a similar method by mapping a graph of indentation stress as a function of indentation strain, identifying a set of relevant δ points, fitting a curve of indentation stress versus indentation strain for each δ point so that the curve is forced through the origin of the graph, and determining the accuracy of the fit, it is possible to determine the zero point. The linearity of the stress-strain curves, and the requirement that they pass through the origin of the graph of S as a function of a, can also be used to find the actual location of the zero point instead of, or in addition to, the method outlined herein.

Optionally, regardless of the graph used, certain data points may be omitted if they are outliers, in accordance with standard convention. This is especially true of the region at very low loads, where factors such as sample orientation and surface roughness may convolute the data, producing a poor signal-to-noise ratio. Removing some of these datum at low loads rarely changes the calculated zero point or modulus significantly, and if removed, would constitute the determination of the “effective zero point” i.e. the zero point one would have obtained had the surface been atomically flat and perfectly normal to the loading direction. This effective zero point, may, or may not, correspond to the first point of contact between the indenter and the surface.

The method of the present invention is unique in that it is a simple, objective, robust, accurate and reproducible method for determining the zero point or effective zero point of a nano-indented material from an existing data set using CSM. In contrast to the prior art, the method of the present invention is advantageous because it relies on actual stiffness measurements collected from the CSM data, which is not inherently sensitive to the zero point/effective zero point or significantly sensitive to vibrations or drift. Therefore, excipient factors that can skew zero point or effective zero point determination do not substantially interfere with the CSM data. Essentially, the method of the present invention uses non zero point sensitive CSM data to correct something without significant interference from other factors.

The method of the present invention may be used to enhance the accuracy and execution of a variety of applications. Currently nearly all indentation models erroneously assume that the indentation is perfectly perpendicular to a flat surface of the solid. The orientation of an indentation relative to a surface of a solid, however, is dependent upon the angle of the solid surface. Therefore, an assumption that the indentation is perpendicular to the sample surface generally results in some degree of inaccuracy regarding the location of the zero point or effective zero point. Using our zero point or effective zero point and the absolute displacement of the indenter tip, we can, by using a minimum of three points, determine the pitch and roll (x and y angle) of a solid. This information may be used to correspondingly position the sample stage via some mechanical, hydraulic or other physical means, so that the solid is perpendicularly oriented with respect to the indenter tip.

Additionally, the present method may also be used with a nanoindenter as well as a surface profilometer, similar to Atomic Force Microscopy (AFM). The surface of the solid may be scanned with the nanoindenter and indented at multiple points along the surface of the solid. This application would enable one to obtain information regarding surface topography and mechanical properties of the solids.

The method of the present application may also be applicable for enhancing the accuracy of nanoindentation analysis and providing a better understanding of contact mechanics.

### EXAMPLES

### Example 1

A graph of S as a function of a may be used to determine the zero point of the nano-indented material using a sensor having a spherical shaped indenter tip. The following equations, which pertain to a spherical shaped indenter tip and are based upon the Hertzian model, disclose a means for calculating contact parameter a. Modified equations that represent other tip geometries are not enumerated but would be obvious to one of ordinary skill in the art.

The stress-strain curve for a nanoindented isotropic elastic material may be calculated from the contact parameter a, the stiffness of the isotropic elastic material S and the composite modulus E_{eff} of Equation 1 (W. C. Oliver and G. M. Pharr: Measurement of hardness and elastic modulus by instrumented indentation: Advances in understanding and refinements to methodology. Journal of Materials Research 19, 3-20 (2004)),

$$a = \frac{S}{2 {E}_{eff}} \qquad ( Equation 1 )$$

where S is defined by Equation 2.

$$\frac{1}{S} = \frac{1}{{S}^{*}} - \frac{1}{{S}_{f}} \qquad ( Equation 2 )$$

S* is the stiffness value of the system, reported by the CSM, and S_{f} is the load-frame stiffness, given by the instrument manufacturer. The composite modulus, E_{eff}, is defined by Equation 3,

$$\frac{1}{{E}_{eff}} = \frac{1 - {υ}^{2}}{E} + \frac{1 - {υ}^{′2}}{{E}^{′}} \qquad ( Equation 3 )$$

where E′ and ν′, respectively, refer to the Young's modulus and Poisson's ratio of an indenter, preferably a diamond indenter; E and ν are Young's modulus and Poisson's ratio of the nano-indented isotropic elastic material. According to Oliver and Pharr (W. C. Oliver and G. M. Pharr: Measurement of hardness and elastic modulus by instrumented indentation: Advances in understanding and refinements to methodology. Journal of Materials Research 19, 3-20 (2004)) and Field and Swain (J. S. Field and M. V. Swain: Determining the Mechanical-Properties Of Small Volumes Of Material From Submicrometer Spherical Indentations. Journal Of Materials Research 10, 101-112 (1995)), the contact parameter a may also be determined by Equation 4,

a=\sqrt{2Rh_{c}−h_{c}²} (Equation 4)

where R is the indenter parameter and the contact depth, h_{c}, is the distance from the circle of contact (i.e. the highest point on the tip where the sample actually touches the surface of the tip) to the maximum penetration depth (i.e. at the apex of the tip) is given by Equation 5, (J. S. Field and M. V. Swain: Determining The Mechanical-Properties Of Small Volumes Of Material From Submicrometer Spherical Indentations. Journal Of Materials Research 10, 101-112 (1995); W. C. Oliver and G. M. Pharr: Measurement of hardness and elastic modulus by instrumented indentation: Advances in understanding and refinements to methodology. Journal of Materials Research 19, 3-20 (2004); S. Basu, A. Moseson, and M. W. Barsoum: On the determination of spherical nanoindentation stress-strain curves. Journal of Materials Research 21, 2628-2637 (2006)).

$${h}_{c} = {h}_{t} - \frac{3}{4} \frac{P}{S} \qquad ( Equation 5 )$$

where P is the indentation load applied to the solid and hₜ is the depth of the indentation in the surface of the solid, measured between an assumed datum parallel to the sample surface and the apex of the indenter tip. Finally, the indentation stress and strain, as defined by Equation 6, is derived from the Hertz equation (J. S. Field and M. V. Swain: Determining The Mechanical-Properties Of Small Volumes Of Material From Submicrometer Spherical Indentations. Journal Of Materials Research 10, 101-112 (1995); W. C. Oliver and G. M. Pharr: Measurement of hardness and elastic modulus by instrumented indentation: Advances in understanding and refinements to methodology. Journal of Materials Research 19, 3-20 (2004); J. S. Field and M. V. Swain: A Simple Predictive Model For Spherical Indentation. Journal Of Materials Research 8, 297-306 (1993); D. Tabor. Hardness of Metals (Clarendon, Oxford, U.K., 1951)) and the work of Sneddon (I. N. Sneddon: The relaxation between load and penetration in the axisymmetric boussinesq problem for a punch of arbitrary profile. Int. J. Engineering Science, 3, 47 (1965))

$$\frac{P}{π {a}^{2}} = \frac{4}{3 π} {E}_{eff} ( \frac{a}{R} ) \qquad ( Equation 6 )$$

The left side of Equation 6 is defined as the indentation stress, mean contact hardness or Meyer hardness (S. Basu, A. Moseson, and M. W. Barsoum: On the determination of spherical nanoindentation stress-strain curves. Journal of Materials Research 21, 2628-2637 (2006); D. Tabor. Hardness of Metals (Clarendon, Oxford, U.K., 1951)). The expression in parenthesis is the indentation strain (S. Basu, A. Moseson, and M. W. Barsoum: On the determination of spherical nanoindentation stress-strain curves. Journal of Materials Research 21, 2628-2637 (2006); D. Tabor. Hardness of Metals (Clarendon, Oxford, U.K., 1951)).

From these equations, a graph of S versus a may be used to determine the zero point of the nanoindented material. S may be obtained from the CSM data collected by the sensor, and Equations 4 and 5 may be used to calculate contact parameter a.

### Example 2

The method of the present invention was found to be effective for determining the zero point of fused silica, sapphire single crystals and polycrystalline iron using indenters of various sizes having a resolution of 1 nm.

A Nano-indenter XP system (MTS, Oak Ridge, Tenn.) with a CSM attachment was used to perform the method of the present invention. The nano-indenter sensor comprises a diamond spherical tip. In this experiment, two tips, with radii of 13.5 μm and 1 μm, were used. The Young's modulus and Poisson's ratio of the diamond indenters were 1140 GPa and 0.07, respectively.

The three sample materials that were in the experiment include: fused silica (GM Associates Inc., Oakland, Calif.); C-orientation sapphire single crystal (Kyocera Industrial Ceramics, Vancouver, Wash.); and iron (99.65%, SurePure Chemetals, Florham Park, N.J.). The Vickers microhardness value was measured on the same surface used for the nanoindentation with an M-400 Hardness Tester, (LECO Corp., St. Joseph, Mich.).

All the tests were carried out with a load rate over load factor of (dP/dt)/P=0.1 and an allowable drift rate of 0.05 nm/s. The load frame stiffness, S_{f} was provided by the manufacturer, and has a value of ˜5.5 MN/m. Maximum load was 690 mN for the fused silica sample and 50 mN for the iron and sapphire samples. The harmonic displacement for the CSM was 2 nm with a frequency of 45 Hz.

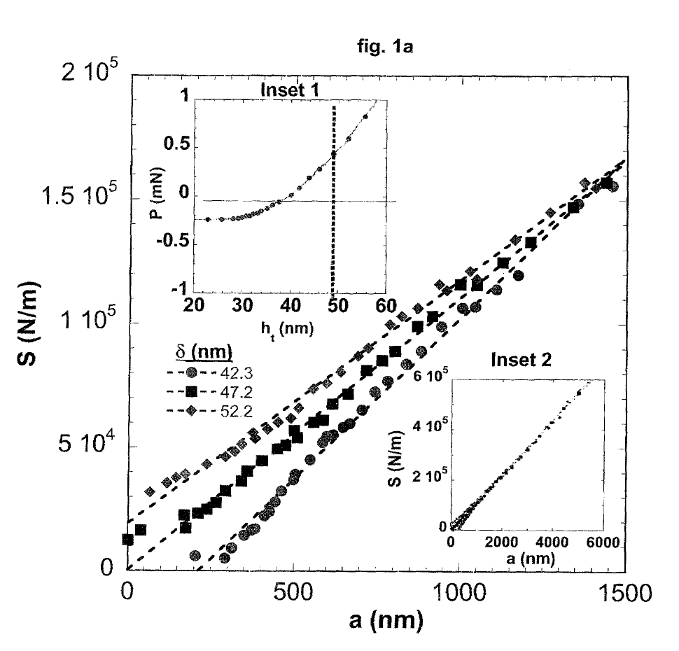

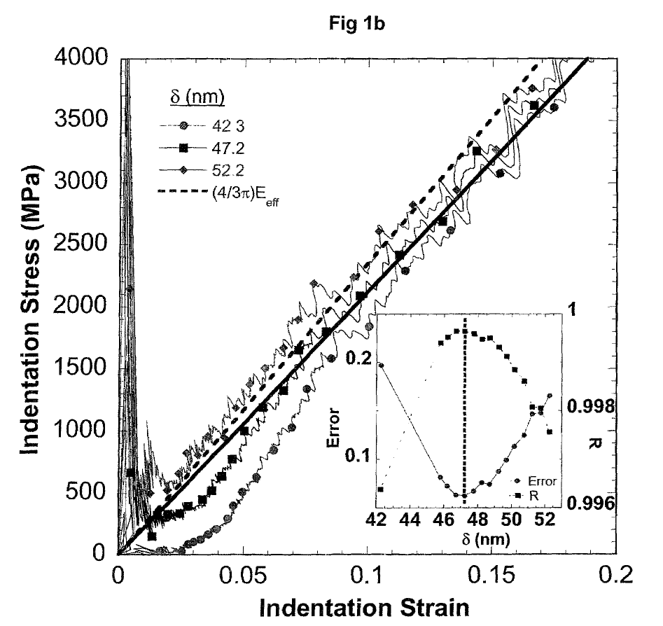

FIG. 1(a) shows an analysis of S versus a using the method of the present invention for three datum points s, over a span of 10 nm, for a fused silica sample using a 13.5 μm indenter. Linear regression of the three datum points δ is represented by dashed lines. FIG. 1(a) shows that datum point δ=47.2 nm has a fitted line that passes through the origin of the graph and is therefore the true zero point for the fused silica sample. Inset 2 of FIG. 1(a) shows the entire data set, wherein it is apparent that after ≈2500 nm, the value of s is no longer of consequence.

FIG. 1(b) shows a graph of indentation stress versus strain, as defined by Equation 6, of the fused silica sample, where the center curve is the true zero point and the solid line represents the linear regression for a first loading region of the center curve. The early data spike is reduced in both magnitude and prevalence as δ increases because: 1) some of the data points occur in the air before the indenter reaches the zero point, identified by having a negative hₜ after the δ correction, and are thus discarded and 2) the magnitude of a, and thus that of the indentation stress, becomes more accurate as δ approaches the zero point. The dashed line represents the expected slope, calculated from 4E_{eff}/3π, and the Inset of FIG. 1(b) is a graph of the linear regression R-values and the standard error of the data that is forced through the origin of the graph, at various δ values.

As shown by Inset 1 of FIG. 1(a), the conventional method of graphing P versus hₜ at a region near the point where S=200 N/m, which according to the prior art supposedly corresponds to the zero point, does not clearly indicate the zero point, which is represented by the dashed line. Notably, the datum point δ=47.2 nm is counterintuitive when compared to Inset 1 of FIG. 1(a), which suggests that P begins to increase around a δ of 10 nm.

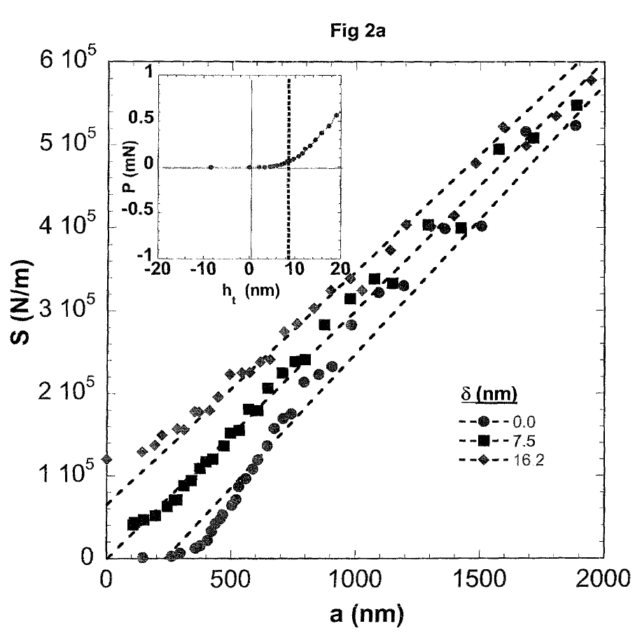

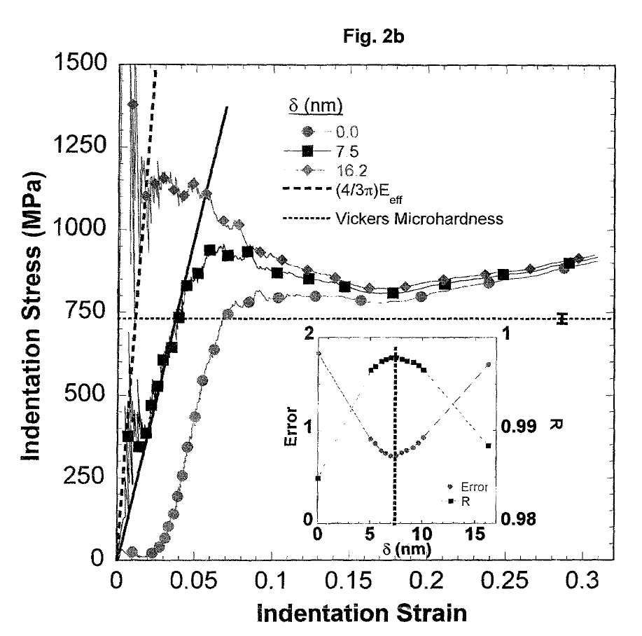

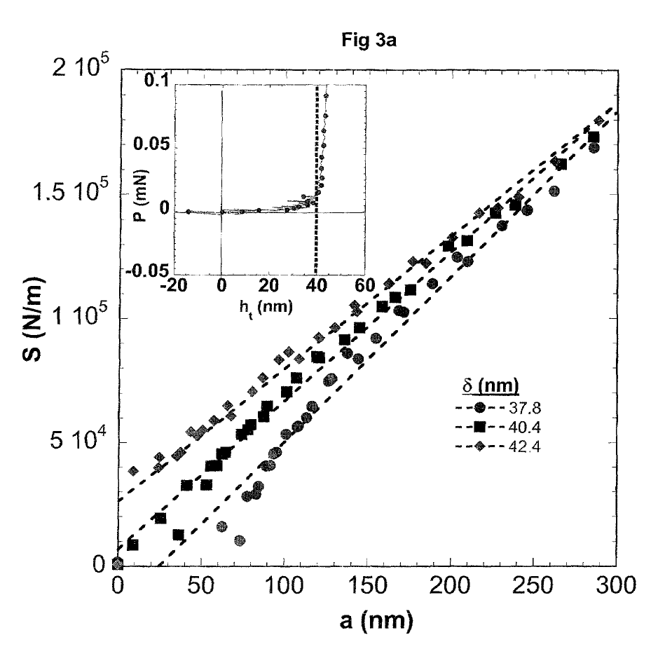

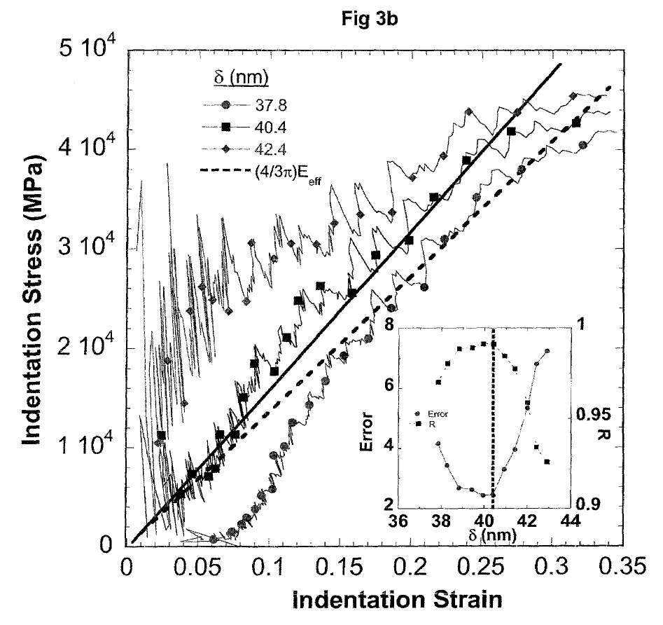

FIGS. 2 and 3 similarly show a zero point analysis for samples of iron and sapphire. FIG. 2(a) is a graph of S versus a using the method of the present invention for three datum points A, over a span of 10 nm, for a sample of iron sample using a 13.5 μm indenter. The zero point occurs at δ=7.5 nm, which is also represented by the dashed line in the Inset of FIG. 2(a). FIG. 2(b) shows a graph of indentation stress versus strain for various datum points s of the iron sample, where the center curve is the true zero point. The solid line represents a linear regression for first loading region of the center curve, and the dashed line is the expected slope as calculated from 4E_{eff}/3π. The Vickers hardness value, shown by the dashed horizontal line in FIG. 2(b), is within a reasonable range of the value expected from our stress versus strain curve, where the curve becomes horizontal. The Inset of FIG. 2(b) shows a graph of the linear regression R-values and the standard error from the data forced through zero, at various s.

Similarly, FIG. 3(a) shows a graph of S versus a using the method of the present invention for three datum points δ, over a span of 10 nm, for a sample of iron sample using a 1 μm indenter. The zero point occurs at δ=40.4 nm, which is also represented by the dashed line in the Inset of FIG. 3(a). In FIG. 3(b), the center curve of the stress versus strain graph represents the true zero point. The solid line represents a linear regression for first loading region of the center curve, and the dashed line is the expected slope as calculated from 4E_{eff}/3π. The Inset of FIG. 3(b) shows a graph of the linear regression R-values and the standard error from the data forced through zero, at various δ. The importance and sensitivity of correctly identifying the zero point is highlighted in the stress versus strain curves. For example, in FIG. 3(b), a difference of only approximately 2 to 3 nm results in significant variations in the indentation stress/strain curves, which previously were left unexplained.

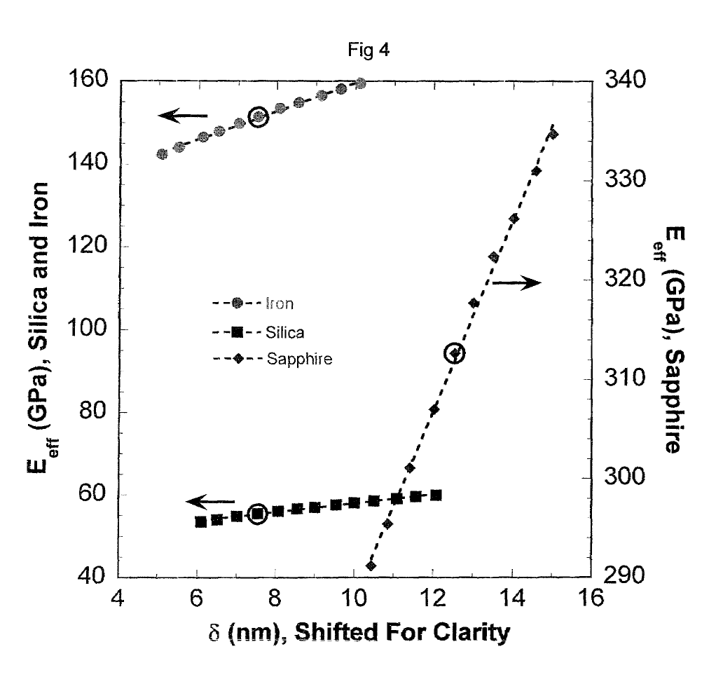

FIG. 4 is a graph of the slopes of the S versus a curves i.e. E_{eff}, for all three samples as a function of δ. The true zero point of each material is circled and the dashed lines represent the linear regression for each data set. Because it is evident that E_{eff} is functionally related to δ, this suggests that an incorrect determination of the zero-point can produce an incorrect determination of the effective moduli. For example, for both iron and sapphire, an error of only ≈2 nm in the choice of the zero point results in a ≈7% error in S, and consequently, E_{eff}.

According to Equation 6, the slope of the indentation stress versus strain should equal 4E_{eff}/3π. The inclined dashed lines shown in FIGS. 1(b), 2(b) and 3(b) represent the 4E_{eff}/3π line; the solid inclined lines, on the other hand, represents the least squares fit of the data points shown in the linear regime and forced through zero. The closer the correspondence between the inclined dashed lines and the solid inclined lines, the greater the accuracy the of the zero point determination

For silica and sapphire, there is a substantial correlation between the dashed lines and the solid lines, supporting the accuracy of the zero point determination for these materials. This is especially true considering that Equation 6 was derived assuming a perfect sphere indenting a perfectly perpendicular, atomically smooth, elastically isotropic surface. The latter is probably only true here for fused silica. The correspondence would have been greater were the results for larger increments of δ also graphed, as done in FIG. 2(b). These factors have also been found to be highly correlated for ZnO (S. Basu, A. Moseson, and M. W. Barsoum: On the determination of spherical nanoindentation stress-strain curves. Journal of Materials Research 21, 2628-2637 (2006); S. Basu and M. W. Barsoum: On the Use of Spherical Nanoindentations to Determine the Deformation Micromechanisms of ZnO Single Crystals. J. Mater. Res., 22, 2470-2477 (2007)), Al (S. Basu, A. Moseson, and M. W. Barsoum: On the determination of spherical nanoindentation stress-strain curves. Journal of Materials Research 21, 2628-2637 (2006)), GaN (S. Basu, M. W. Barsoum, A. D. Williams, and T. D. Moustakas: Spherical Nano-indentation and Deformation Mechanisms in Free-standing GaN Films. J. App. Phys. 100, 083522 (2007)) and more recently, LiNbO3 (S. Basu, A. Zhou, and M. W. Barsoum: Micromechanics of Deformation Under a Spherical Indenter and Indirect Observation of Reversible Dislocation Motion in a LiNbO3 Single Crystal. J. Mater. Res., 23, 1134-1138 (2008)). Notably, the dashed line for iron is approximately 3 times steeper than its solid line. It has been determined that this difference is not a result of an error in the method of the present application, but rather reflects a physical phenomena most probably related to the elastic anisotropy of iron, which is consistent with previous results (Al (S. Basu, A. Moseson, and M. W. Barsoum: On the determination of spherical nanoindentation stress-strain curves. Journal of Materials Research 21, 2628-2637 (2006)).

The present invention may also be implemented in the form of a computer program or by a computer programmed to carry out all or portions of the method of the present invention.

Further examples may be found in “Spherical Nanoindentation: Insights And Improvements, Including Stress-Strain Curves and Effective Zero Point Determination,” which is hereby incorporated by reference herein.

1. A method for determining the zero point or effective zero point of a nano-indented material comprising the steps of:
a) obtaining continuous stiffness measurement oscillation data for a nano-indented material;
b) selecting at least one data point;
c) plotting a stiffness of said material as a function of a contact parameter of said material for said data point to form a plot;
d) applying a linear regression analysis to plot to determine the degree to which said data point approximates a line that passes through an origin of said plot; and
e) selecting a zero point or effective zero point from said data point, for which said linear regression most closely approximates a line that passes through the origin of said plot.

2. The method of claim 1, wherein said method may be used to determine the zero point or effective zero point of a material selected from the group consisting of: a solid material and a semi-solid material.

3. The method of claim 1, wherein step e further comprises the step of analyzing a fit of said linear regression.

4. The method of claim 3, wherein said step of analyzing a fit employs a measure selected from a standard error, a correlation coefficient and a combination thereof.

5. The method of claim 4, wherein the selected zero point or effective zero point is a data point that minimizes the standard error and/or maximizes said correlation coefficient.

6. The method of claim 1, wherein said selected zero point or effective zero point is accurate within a resolution of about 2 nm or less.

7. The method of claim 1, wherein said selected zero point or effective zero point is accurate within a resolution of about 1 nm or less.

8. The method of claim 1, further comprising the step of using said zero point or effective zero point to position said material relative to a nano-indenter.

9. A method for determining the zero point or effective zero point of a nano-indented material comprising the steps of:
a) obtaining continuous stiffness measurement oscillation data for a nanoindented material;
b) selecting at least one data point;
c) plotting a first graph of a stiffness of said material as a function of a contact parameter of said material for said data point;
d) plotting a second graph of indentation stress of said material as a function of indentation strain of said material;
e) applying a linear regression analysis to said first and second graphs to determine the degree to which said data point approximates a line that passes through an origin of said first and second graphs; and
f) selecting a zero point or effective zero point from said data point, for which said linear regression most closely approximates a line that passes through the origin of said first and second graphs.

10. The method of claim 9, wherein step (e) further comprises the step of analyzing a fit of said linear regression.

11. The method of claim 10, wherein the step of analyzing a fit of said linear regression uses a measure selected from a standard error, a correlation coefficient and a combination thereof.

12. The method of claim 11, wherein the selected zero point or effective zero point is a data point that minimizes a standard error, maximizes said correlation coefficient or both.

13. The method of claim 9, wherein said selected zero point or effective zero point is accurate within a resolution of about 2 nm or less.

14. The method of claim 9, wherein said selected zero point or effective zero point is accurate within a resolution of about 1 nm or less.

15. A method for determining the zero point or effective zero point of a nano-indented material comprising the steps of:
a) obtaining continuous stiffness measurement oscillation data for a nano-indented material;
b) selecting at least one data point;
c) plotting a first graph of indentation stress of said material as a function of indentation strain of said material;
d) applying a linear regression analysis to said graph to determine the degree to which said data point approximates a line that passes through an origin of said graph; and
e) selecting a zero point or effective zero point from said data point, for which said linear regression most closely approximates a line that passes through the origin of said graph.

16. The method of claim 15, wherein step (e) further comprises the step of analyzing a fit of said linear regression.

17. The method of claim 16, wherein said step of analyzing a fit employs a measure selected from a standard error, a correlation coefficient and a combination thereof.

18. The method of claim 17, wherein the selected zero point or effective zero point is a data point that minimizes a standard error, maximizes said correlation coefficient or both.

19. The method of claim 15, wherein said selected zero point or effective zero point is accurate within a resolution of about 2 nm or less.

20. The method of claim 15, wherein said selected zero point or effective zero point is accurate within a resolution of about 1 nm or less.
